(19) United States
(12) Patent Application Publication
(10) Pub. No.: US 2009/0205686 A1
(43) Pub. Date: Aug. 20, 2009

(54) WAFER CLEANING APPARATUS

(75) Inventors: Ming-Hsing Kao, Singapore (SG); NGO CHIAN MING, Johor (MY); TAN BOON SIONG, Singapore (SG)

Correspondence Address: J C PATENTS, INC., 4 VENTURE, SUITE 250, IRVINE, CA, 92618, US

(73) Assignee: UNITED MICROELECTRONICS CORP., Hsinchu (TW)

(21) Appl. No.: 12/033,286

(22) Filed: Feb. 19, 2008

(51) Int. Cl. B08B 3/02

(52) U.S. Cl. 134/95.3; 134/153

(57) ABSTRACT

A wafer cleaning apparatus used for cleaning a first uncleaned surface of a wafer is provided. The wafer cleaning apparatus includes a case, a spin device, a cover, at least one first spray bar, and at least one exhaust device. The spin device is disposed in the case and used for carrying the wafer and spinning perpendicularly to the ground. The cover is disposed in the case and used for covering the spin device. The first spray bar is disposed at one side of the spin device and used for spraying a volatile cleaning solution onto the first uncleaned surface of the wafer, in which the sprayed volatile cleaning solution is of a bar shape. The exhaust device is disposed on the sidewall of the case.

### BACKGROUND OF THE INVENTION

1. Field of the Invention

The present invention generally relates to a semiconductor apparatus, in particular, to a wafer cleaning apparatus.

2. Description of Related Art

In the manufacturing process of integrated circuit (IC) elements, the most frequent step lies in cleaning wafers. The step of cleaning the wafer aims at removing organic compounds, metallic impurities, or particles adhered on the surface of the wafer after the semiconductor manufacturing process (for example, chemical-mechanical polishing or other process). Such contaminants may seriously affect the subsequent manufacturing process of the product. The contamination caused by the metallic impurities may result in electricity leakage at the p-n junction, reducing a fewer carriers' lifetime, and lowering the breakdown voltage of the gate oxide layer. The adhered particles may affect the integrity of pattern transfer in the photolithography process, and even results in short circuit of the circuit structure. Therefore, in the wafer cleaning process, the organic compounds, metallic impurities, and particles adhered on the surface of the wafer must be effectively removed.

In the conventional art, when the wafer is cleaned, the wafer is placed on the spin table and spins parallel to the ground; then, the water injection mechanism is used to spray water to the wafer for cleaning, while the wafer is spinning; and then the water thereon is removed through spinning the wafer. However, after the cleaning step is finished, water marks are usually still found on the surface of the wafer, such that the cleaning efficiency is rather poor, which further reduces the quality and yield of the semiconductor device.

### SUMMARY OF THE INVENTION

Accordingly, the present invention is directed to a wafer cleaning apparatus, which is capable of effectively improving the wafer cleaning efficiency.

The present invention provides a wafer cleaning apparatus, applied to cleaning a first uncleaned surface of the wafer. The wafer cleaning apparatus includes a case, a spin device, a cover, at least one first spray bar, and at least one exhaust device. The spin device is disposed in the case, for carrying the wafer and spinning perpendicularly to the ground. The cover is disposed in the case, for covering the spin device. The first spray bar is disposed at one side of the spin device, for spraying a volatile cleaning solution onto the first uncleaned surface of the wafer. The sprayed volatile cleaning solution is of a bar shape. The exhaust device is disposed on a sidewall of the case.

According to an embodiment of the present invention, in the wafer cleaning apparatus, the spin device includes a spin table.

According to an embodiment of the present invention, the wafer cleaning apparatus further includes a plurality of fixing mechanisms disposed on the spin device, for fixing the wafer on the spin device.

According to an embodiment of the present invention, in the wafer cleaning apparatus, the fixing mechanisms include a plurality of fixing clamps.

According to an embodiment of the present invention, in the wafer cleaning apparatus, the fixing mechanisms include a sucker.

According to an embodiment of the present invention, in the wafer cleaning apparatus, a spraying manner of the first spray bar includes spraying towards a radial direction of the wafer.

According to an embodiment of the present invention, in the wafer cleaning apparatus, when the number of the at least one first spray bar is more than one, the first spray bars are arranged to be mutually crossed into a radial configuration.

According to an embodiment of the present invention, in the wafer cleaning apparatus, the first spray bar includes at least one line of point-shaped spray holes.

According to an embodiment of the present invention, in the wafer cleaning apparatus, the first spray bar includes at least one line of bar-shaped spray hole.

According to an embodiment of the present invention, in the wafer cleaning apparatus, the spin device includes a plurality of rolling clamp wheels.

According to an embodiment of the present invention, the wafer cleaning apparatus further includes at least one second spray bar disposed at the other side of the spin device, for spraying the volatile cleaning solution onto a second uncleaned surface of the wafer, in which the sprayed volatile cleaning solution is of a bar shape.

According to an embodiment of the present invention, in the wafer cleaning apparatus, the second uncleaned surface is an opposite surface of the first uncleaned surface.

According to an embodiment of the present invention, in the wafer cleaning apparatus, a spraying manner of the second spray bar includes spraying towards a radial direction of the wafer.

According to an embodiment of the present invention, in the wafer cleaning apparatus, when the number of the at least one second spray bar is more than one, the second spray bars are arranged to be mutually crossed into a radial configuration.

According to an embodiment of the present invention, in the wafer cleaning apparatus, the second spray bar includes at least one line of point-shaped spray holes.

According to an embodiment of the present invention, in the wafer cleaning apparatus, the second spray bar includes at least one line of bar-shaped spray hole.

According to an embodiment of the present invention, in the wafer cleaning apparatus, the volatile cleaning solution is isopropyl alcohol or propanone.

According to an embodiment of the present invention, the wafer cleaning apparatus further includes a water injection device disposed in the cover, for providing water to the wafer.

According to an embodiment of the present invention, in the wafer cleaning apparatus, the water includes deionized water.

According to an embodiment of the present invention, in the wafer cleaning apparatus, when the number of the at least one exhaust device is more than one, the exhaust devices are disposed on a plurality of sidewalls of the case.

In view of the above, the wafer cleaning apparatus provided by the present invention has the first spray bar, and the spin device is used to spin the wafer, so as to more uniformly and quickly spray the volatile cleaning solution onto the first uncleaned surface of the wafer, thereby improving the cleaning efficiency.

In addition, when the wafer cleaning apparatus provided by the present invention dries the wafer, as the cleaning solution is volatile, and the drying speed is quickened by spinning the wafer and pumping the air, no residues are left on the wafer, thereby improving the quality and yield of the semiconductor device.

In addition, since the wafer cleaning apparatus provided by the present invention has the second spray bar, it can be used to clean the second uncleaned surface of the wafer, so as to sufficiently clean the wafer.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of a wafer cleaning apparatus according to a first embodiment and a second embodiment of the present invention.

FIG. 2 is a cross-sectional view of the wafer cleaning apparatus according to the first embodiment of the present invention, taken along a section line A-A′ in FIG. 1.

FIGS. 3 and 4 are front views of a spray bar according to the first embodiment of the present invention.

FIG. 5 is a schematic view of an arrangement manner of spray bars according to the first embodiment of the present invention.

FIG. 6 is a cross-sectional view of a wafer cleaning apparatus according to the second embodiment of the present invention, taken along the section line A-A′ in FIG. 1.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### First Embodiment

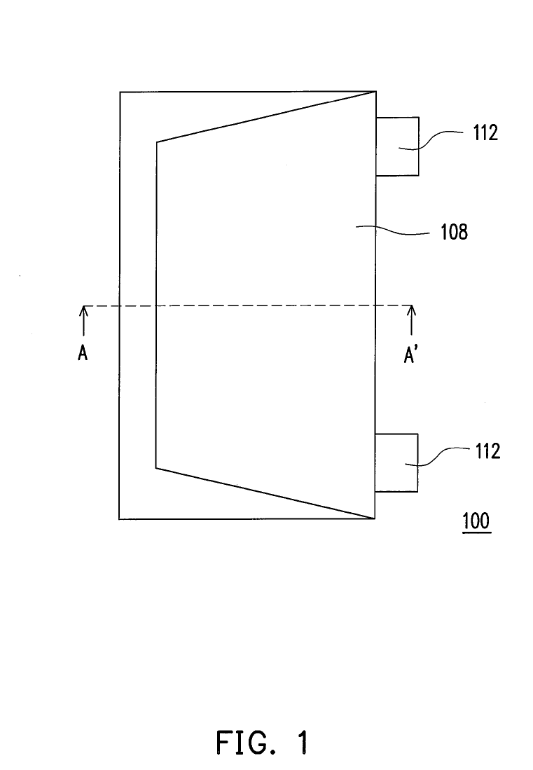

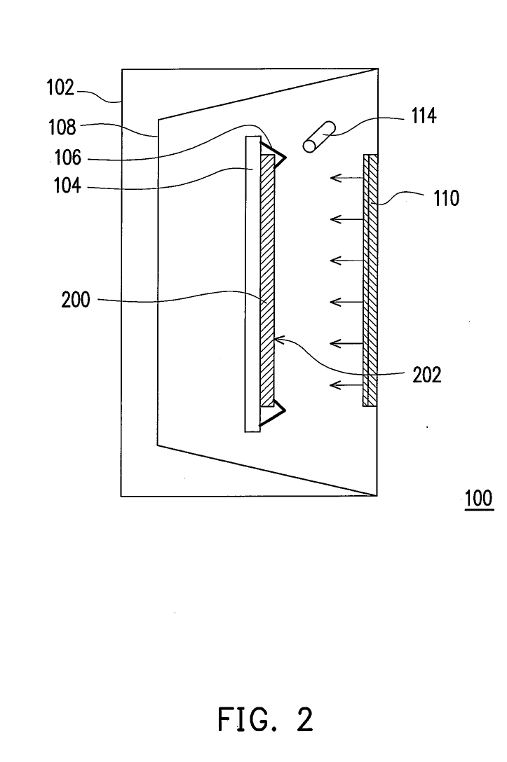

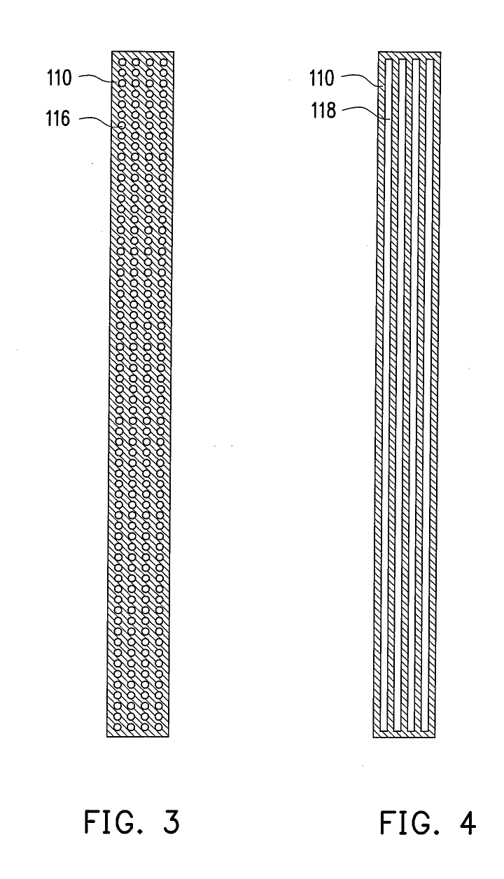

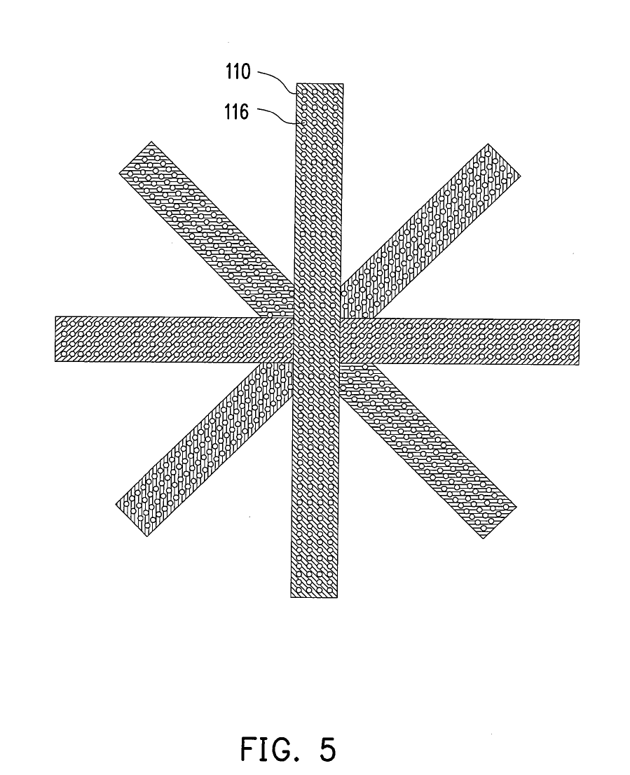

FIG. 1 is a top view of a wafer cleaning apparatus according to a first embodiment and a second embodiment of the present invention. FIG. 2 is a cross-sectional view of the wafer cleaning apparatus according to the first embodiment of the present invention, taken along a section line A-A′ in FIG. 1. FIGS. 3 and 4 are front views of a spray bar according to the first embodiment of the present invention. FIG. 5 is a schematic view of an arrangement manner of spray bars according to the first embodiment of the present invention.

Referring to FIGS. 1 and 2, a wafer cleaning apparatus 100 is used for cleaning an uncleaned surface 202 of a wafer 200. The uncleaned surface 202 may be a front surface or a back surface of the wafer, and in this embodiment, the uncleaned surface 202 is, for example, the front surface of the wafer 200.

The wafer cleaning apparatus 100 includes a case 102, a spin device 104, a plurality of fixing mechanisms 106, a cover 108, a spray bar 110, exhaust devices 112, and a water injection device 114.

The spin device 104 is disposed in the case 102, for carrying the wafer 200 and spinning perpendicularly to the ground. The spin device 104 is, for example, a spin table driven by a motor. In addition, the spin device 104 in the wafer cleaning apparatus 100 spins perpendicularly to the ground, so the wafer cleaning apparatus 100 may be designed into an upright style, instead of the platform-shaped wafer cleaning apparatus in the conventional art, so as to utilize the space more effectively and flexibly.

The fixing mechanism 106 is disposed on the spin device 104, for fixing the wafer 200 on the spin device 104, so as to prevent the wafer 200 from separating from the spin device 104 during spinning. The fixing mechanism 106 is, for example, a fixing clamp. In other embodiments, the fixing mechanism 106 could be a sucker.

The cover 108 is disposed in the case 102, for covering the spin device 104 to protect the means disposed therein and to prevent the solution used in the cleaning process from splashing.

The spray bar 110 is disposed at one side of the spin device 104, for spraying a volatile cleaning solution onto the uncleaned surface 202 of the wafer 200, and the sprayed volatile cleaning solution is of a bar shape, such that the volatile cleaning solution is more uniformly and quickly sprayed onto the uncleaned surface 202 of the wafer 200. The number of the spray bar 110 may be one or more than one. The spraying manner of the spray bar 110 is, for example, to spray towards a radial direction of the wafer 200, so as to more uniformly spray the volatile cleaning solution onto the uncleaned surface 202 of the wafer 200. The volatile cleaning solution is, for example, isopropyl alcohol or propanone, and other volatile liquid.

It should be noted that, in this embodiment, the uncleaned surface 202 faces the openings of the spray bar 110. In other embodiments, according to the arrangement of the uncleaned surface 202, the spray bar 110 could be disposed at the other side of the spin device 104.

In addition, referring to FIGS. 3 and 4, the reason why the volatile cleaning solution sprayed by the spray bar 110 is of a bar shape lies in that, the spray bar 110 may include at least one line of point-shaped spray holes 116 (four lines shown in FIG. 3) or at least one line of bar-shaped spray hole 118 (four lines shown in FIG. 4).

In addition, referring to FIG. 5, the number of the spray bar 110 is, for example, four, but it is not intended to limit the present invention. At this time, the spray bars 110 are arranged to be mutually crossed into a radial configuration, so as to improve the efficiency and uniformity for spraying the volatile cleaning solution.

Referring to FIGS. 1 and 2, the exhaust devices 112 is disposed on a sidewall of the case 102, for sucking the air out of the cavity of the case 102, so as to prevent the volatile cleaning solution from escaping into the external environment to cause contaminations after volatilization, and meanwhile quicken the drying speed of the wafer 200. The exhaust device 112 is, for example, a vacuum pump. The number of the exhaust device 112 is one or more than one. When the number of the exhaust device 112 is more than one, the exhaust devices 112 may be disposed on the same sidewall of the case 102, or may be disposed on a plurality of sidewalls of the case 102. In this embodiment, the two exhaust devices 112 are, for example, disposed on the same sidewall of the case 102.

The water injection device 114 is disposed in the cover 108, for providing water to the wafer 200, so as to assist in cleaning the uncleaned surface 202 of the wafer 200, in which the used water is deionized water.

As known from the first embodiment that, the wafer cleaning apparatus 100 has the spray bar 110, and the spin device 104 is further used to spin the wafer 200, so as to enhance the uniformity and speed for spraying the volatile cleaning solution onto the uncleaned surface 202 of the wafer 200, thereby improving the cleaning efficiency.

In addition, when the wafer cleaning apparatus 100 dries the wafer 200, since the cleaning solution itself is volatile, and the drying speed is quickened by spinning the wafer 200 and sucking the air, no residues are left on the wafer 200, thereby improving the quality and yield of the semiconductor device.

### Second Embodiment

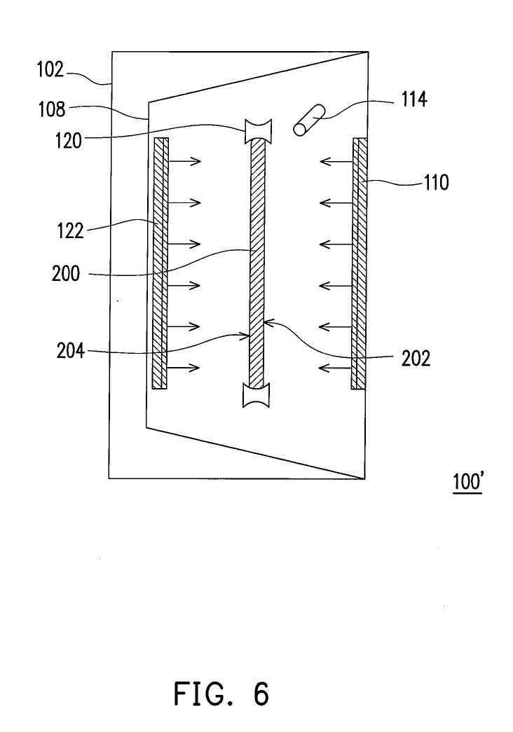

FIG. 6 is a cross-sectional view of a wafer cleaning apparatus according to the second embodiment of the present invention, taken along the section line A-A′ in FIG. 1.

Referring to FIGS. 1, 2, and 6, a wafer cleaning apparatus 100′ is used for cleaning the uncleaned surface 202 and an uncleaned surface 204 of the wafer 200. The uncleaned surface 202 is an opposite surface of the uncleaned surface 204, which are respectively a front surface or a back surface of the wafer 200.

The wafer cleaning apparatus 100′ includes a case 102, a cover 108, a spray bar 110, exhaust devices 112, a water injection device 114, a spin device 120, and a spray bar 122. In FIG. 6, the same numerals as that in FIG. 2 are used to mark those elements the same as that of FIG. 2, which will not be repeatedly described herein.

Both the wafer cleaning apparatus 100′ in FIG. 6 and the wafer cleaning apparatus 100 in FIG. 2 similarly use the volatile cleaning solution to clean the wafer 200. The difference there-between lies in that, the model of the spin device 120 in FIG. 6 is different from that of the spin device 104 in FIG. 2, and besides the spray bar 110 disposed at one side of the spin device 120, the wafer cleaning apparatus 100′ in FIG. 6 further includes the spray bar 122 disposed at the other side of the spin device 120.

The spin device 120 is, for example, a plurality of rolling clamp wheels, for clamping the wafer 200 and spinning the wafer 200.

The spray bar 122 is used to spray the volatile cleaning solution onto the uncleaned surface 204 of the wafer 200, and the sprayed volatile cleaning solution is of a bar shape. The number of the spray bar 122 may be one or more than one. Other characteristics, implementing manners, and efficacies of the spray bar 122 are approximately the same as that of the spray bar 110, which thus will not be described here.

It should be noted that, the water injection device 114 is, for example, a movable water injection device, which is capable of providing water onto the uncleaned surface 202 and the uncleaned surface 204 of the wafer 200. In other embodiments, the wafer cleaning apparatus 100′ may include two water injection devices 114, so as to simultaneously provide water to the uncleaned surface 202 and the uncleaned surface 204 of the wafer 200.

It can be known from the second embodiment that, the wafer cleaning apparatus 100′ has a spray bar 110 and a spray bar 122 respectively at two sides of the spin device 120, so as to clean the uncleaned surface 202 and the uncleaned surface 204 of the wafer 200 simultaneously, so as to clean the wafer 200 thoroughly.

To sum up, the above embodiments of the present invention at least has the following advantages.

1. The wafer cleaning apparatus of the present invention can more uniformly and quickly spray the volatile cleaning solution onto the uncleaned surface of the wafer, so as to prevent the water marks from being produced and greatly improve the cleaning efficiency.

2. The wafer cleaning apparatus of the present invention can prevent residues from being left on the wafer, so as to improve the quality and yield of the semiconductor device.

3. In the wafer cleaning apparatus of the present invention, when the spray bars are respectively provided at the two sides of the spin device, the wafer can be cleaned thoroughly.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wafer cleaning apparatus, applied to cleaning a first uncleaned surface of a wafer, comprising:
a case;
a spin device, disposed in the case, for carrying the wafer and spinning perpendicularly to the ground;
a cover, disposed in the case, for covering the spin device;
at least one first spray bar, disposed at one side of the spin device, for spraying a volatile cleaning solution onto the first uncleaned surface of the wafer, wherein the sprayed volatile cleaning solution is of a bar shape; and
at least one exhaust device, disposed on a sidewall of the case.

2. The wafer cleaning apparatus according to claim 1, wherein the spin device comprises a spin table.

3. The wafer cleaning apparatus according to claim 2, further comprising a plurality of fixing mechanisms disposed on the spin device, for fixing the wafer on the spin device.

4. The wafer cleaning apparatus according to claim 3, wherein the fixing mechanisms comprise a plurality of fixing clamps.

5. The wafer cleaning apparatus according to claim 3, wherein the fixing mechanisms comprise a sucker.

6. The wafer cleaning apparatus according to claim 1, wherein a spraying manner of the at least one first spray bar comprises spraying towards a radial direction of the wafer.

7. The wafer cleaning apparatus according to claim 1, wherein when the number of the at least one first spray bar is more than one, the first spray bars are arranged to be a mutually crossed into a radial configuration.

8. The wafer cleaning apparatus according to claim 1, wherein the at least one first spray bar comprises at least one line of point-shaped spray holes.

9. The wafer cleaning apparatus according to claim 1, wherein the at least one first spray bar comprises at least one line of bar-shaped spray hole.

10. The wafer cleaning apparatus according to claim 1, wherein the spin device comprises a plurality of rolling clamp wheels.

11. The wafer cleaning apparatus according to claim 10, further comprising at least one second spray bar disposed at the other side of the spin device, for spraying the volatile cleaning solution onto a second uncleaned surface of the wafer, wherein the sprayed volatile cleaning solution is of a bar shape.

12. The wafer cleaning apparatus according to claim 11, wherein the second uncleaned surface is an opposite surface of the first uncleaned surface.

13. The wafer cleaning apparatus according to claim 11, wherein a spraying manner of the at least one second spray bar comprises spraying towards a radial direction of the wafer.

14. The wafer cleaning apparatus according to claim 11, wherein when the number of the at least one second spray bar is more than one, the second spray bars are arranged to be mutually crossed into a radial configuration.

15. The wafer cleaning apparatus according to claim 11, wherein the at least one second spray bar comprises at least one line of point-shaped spray holes.

16. The wafer cleaning apparatus according to claim 11, wherein the at least one second spray bar comprises at least one line of bar-shaped spray hole.

17. The wafer cleaning apparatus according to claim 1, wherein the volatile cleaning solution is isopropyl alcohol or propanone.

18. The wafer cleaning apparatus according to claim 1, further comprising a water injection device disposed in the cover, for providing water to the wafer.

19. The wafer cleaning apparatus according to claim 1, wherein the water comprises deionized water

20. The wafer cleaning apparatus according to claim 1, wherein when the number of the at least one exhaust device is more than one, the exhaust devices are disposed on a plurality of sidewalls of the case.
